(19) United States
(12) Patent Application Publication
(10) Pub. No.: US 2022/0375357 A1
(43) Pub. Date: Nov. 24, 2022

(54) Cloud-based Adaptive Learning System for Early Childhood Education

(71) Applicants: Emi N. Harry, Bronx, NY (US); Onengiyeofori C. Harry, Richardson, TX (US)

(72) Inventors: Emi N. Harry, Bronx, NY (US); Onengiyeofori C. Harry, Richardson, TX (US)

(21) Appl. No.: 17/749,152

(22) Filed: May 20, 2022

Related U.S. Application Data
(60) Provisional application No. 63/190,993, filed on May 20, 2021.

(51) Int. Cl. G09B 5/00; G09B 19/00; G06K 9/62; G06N 20/00

(52) U.S. Cl. CPC G09B 5/00; G09B 19/00; G06K 9/6263; G06N 20/00; G06Q 50/20

(57) ABSTRACT

A method for assessing the educational needs of a subject, particularly a child in an educational setting. A system for assessing the learning rate and educational level of at least one subject, particularly students in an educational setting such as a school. An educational environment is created that transforms the learning experience and ensures that learners stay connected to the real world by honing social and communication skills. The technology can be a supplement in and out of the classroom. Advanced machine learning can be used to understand the learning rate of a subject which can determine the delivery speed of educational content. If a subject has not attained the desired learning outcome at each level, the system can keep that subject in a reinforcing learning loop until the subject attains the desired learning outcome. Virtual reality can be used to create an engaging environment.

### BACKGROUND

The present technology relates to methods and devices for assessing the learning rate and level of at least one Learner, particularly students in an educational setting such as a school.

Early childhood education is essential as it lays the foundation for a child's future success. Unfortunately, a child's parent or guardian's socioeconomic status often determines the child's access to premium early childhood education. Further, every child learns at a different rate. Therefore, the lack of access to early childhood premium education can exacerbate existing disparities in learning rates amongst children of different socioeconomic classes, leading to increased differences in overall measured learning rates among children taught in the same educational setting. As a result, it becomes difficult for educational instructors to adapt and broaden their pedagogical approach to meet all of their learners' needs.

For educational instructors to adapt and broaden their pedagogical approach, they first must ascertain the individual learning rates of each of their Learners. Once each Learner's learning rate is ascertained, educational instructors can focus time and resources on each specific Learner's needs, therefore improving the overall quality of their education.

Products that allow for individualized learning are commercially available. For example, LeapFrog™ and ABCMouse™ sell such products. The LeapFrog LeapPad Academy® learning tablet is preloaded with apps covering math, reading, writing, coding, problem-solving, and creativity skills. It also includes parental controls that can be used to set time limits, expand content and add websites to LeapSearch®, LeapFrog's kid-safe web browser. ABCMouse offers a step-by-step Learning Path through its curriculum, offering a designed in several levels. These products can be useful because they allow children to learn independently and at their desired pace. But such curricula are fixed and cannot adapt to each child's needs. Further, these curricula are intended to be used in an individual setting. They are not able to be utilized in a group learning setting.

Thus, none of the existing products provide an adaptive learning system that can also be utilized in a group learning setting. The need for such a learning system is particularly prevalent in educational settings where children do not have access to premium early childhood educational resources.

### SUMMARY OF THE DISCLOSED TECHNOLOGY

In certain embodiments, the present technology is directed to a method of assessing a subject's educational needs, the method comprising the steps of:
(a) Providing the subject with an Initial Assessment, the results of the Initial Assessment comprising: a Cognitive Quotient, a Learning Rate, a Preferred Learning Style, and an Educational Level;
(b) Creating a customized Educational Curriculum based on the results of the Initial Assessment, by forming a Learning Path determined by the Cognitive Quotient, Learning Rate, Preferred Learning Style and Educational Level.

In certain embodiments, the Initial Assessment comprises: (i) an Educational Level Placement Test; and (ii) a Learning Style Test; wherein the Educational Level is calculated from the Educational Level Placement Test; the Preferred Learning Style is calculated from the Learning Style Test; and the Learning Rate and the Cognitive Quotient are calculated from both the Educational Level Placement Test and the Learning Style Test.

In certain embodiments, the Educational Level Placement Test comprises a Verbal Test, a Quant Test, a Social Test, and a Disorders Test; wherein the subject must take the Verbal Test, Quant Test, and Social Test, while said Disorders Test operates concurrently and passively during each of said Verbal Test, Quant Test, and Social Test; wherein the Verbal Test, Quant Test, and Social Test together comprise the Maze Game; wherein the results of the Verbal Test, Quant Test, Social Test and Disorders Tests together determine the Learner's Educational Level.

In certain embodiments, the Learning Style test comprises one or more Lessons connected to one or more Tests; wherein the Educational Level calculated is used to randomly select a Lesson and randomly apply a Learning Style from a library of learning styles to the Lesson, the subject watches the Lesson in which the selected Learning Style is applied, the subject takes a Test connected to the Lesson, wherein one Test comprises a Maze Game, and the result of the Test is used to determine the Learner's Preferred Learning Style.

In certain embodiments, the subject watches Lessons in the Educational Curriculum through the Learning Path, and progresses through the Educational Curriculum.

In certain embodiments, the subject's Cognitive Quotient, Learning Rate, Educational Level, and Preferred Learning Style are updated based on the subject's progress through the Educational Curriculum.

In certain embodiments, the present technology is directed to a system for assessing a subject's educational needs, the system comprising: Two apparatuses each comprising: a graphical interface, a central processing unit configured to accept input from a user through an input element; wherein the two or more apparatuses are connected through a communicational link; and wherein the first apparatus is operated by a Supervisor, and the second apparatus is operated by a Learner; the system configured such that:
(a) the Supervisor registers the Learner through the first apparatus;
(b) the Supervisor subjects the Learner to an Initial Assessment, wherein the results of the Initial Assessment are a Cognitive Quotient, a Learning Rate, a Preferred Learning Style, and an Educational Level; and these results are displayed to the Supervisor through the first apparatus;
(c) the Supervisor provides the Learner with an Educational Curriculum based on the results of the Initial Assessment, by forming a Learning Path for the Learner determined by the Learner's Cognitive Quotient, Learning Rate, Preferred Learning Style and Educational Level;
(d) the Learner starts the Educational Curriculum and a Maze Game;
(e) the Supervisor contemporaneously monitors, through the first apparatus, one or more Learner's activities in the Educational Curriculum and Maze Game while operating the second apparatus; and
(f) the Learner's Learning Rate and Cognitive Quotient are recalculated based on the results of the Learner's progress through the Educational Curriculum and Maze Game.

In certain embodiments, the input element comprises a touch screen, microphone, keyboard, video camera or a picture scanner capable of scanning and uploading pictures or photographs.

In certain embodiments, the system further comprises a third apparatus operated by a second Learner.

In certain embodiments, the system can further comprise a third apparatus operated by a second Learner.

In certain embodiments, the system can further comprise more than three apparatuses operated by additional Learners.

### BRIEF DESCRIPTION OF THE DRAWINGS

FIG. 1 shows an embodiment of the present technology in which the Supervisor can manage the system.

FIG. 2 shows an embodiment of the present technology in which the Learner takes an Initial Assessment, progresses through the Curriculum, and the Supervisor can monitor the Learner's progress.

### DETAILED DESCRIPTION

### Background

The present technology was developed to meet a prevalent need in educational systems caused by lapses in access to quality education in low-income neighborhoods and slums of both developing and developed countries. In certain embodiments, the technology can create a robust educational environment designed to transform the learning experience while ensuring that learners stay connected to the real world by honing their social and communication skills.

The current technology is unique because in certain embodiments, it uses advanced machine learning to understand the learning rate of the Learner. The measured learning rate can determine the speed at which the educational content is delivered to the Learner. If the Learner has not attained the desired learning outcome at each level, the systems herein can keep that Learner in a reinforcing learning loop until the Learner attains the desired learning outcome. Additionally, in certain embodiments, the technology can use virtual reality which can create an engaging environment for the Learner.

In certain embodiments, the technology is directed to an adaptive learning platform for early childhood education. The technology can be a supplemental tool to be used in and out of the classroom, by teachers, parents, or guardians, which can adapt to each Learner's learning rate.

In certain embodiments, the technology can use advanced machine learning or artificial intelligence to learn a Learner's needs and adapts to focus on those needs, which can ensure that no child regardless of social economic quotient is left behind.

In certain embodiments, the technology can be a cloud-based adaptive learning software for early childhood education, comprising of AI-driven educational content. In certain embodiments, the technology can have a front-end and a back end. The front-end of the product can have two main components, the first front end component being the lesson section, and the second front end component being the practice section, which can be pre-defined learning paths according to the age of the Learner. The lessons can be animated educational cartoon episodes, e.g., 5 minutes to 45 minutes long in duration. In certain embodiments' the lessons can be in one or more of the three categories: verbal reasoning, quantitative reasoning, and social reasoning, while one or more practices are games tied to each lesson.

In certain embodiments, the back-end of technology can be programmed to ensure that the Learners keep repeating lessons until they are able to pass respective gamified practice levels. The system can also calculate the Learner's Learning Rate based on the tracking of Learner's activities during game play. The derived Learning Rate can be used to then adjust the periods for lessons, can focus the content on areas of difficulty or the practice frequency, by applying machine learning algorithms.

In certain embodiments, the technology can be installed on individual computers, e.g., Android tablets which can be made available to every Learner. In certain embodiments, on the administrative portal of the technology, a Supervisor can monitor the activities and progress of all the Learners in their care. The educational content can be focused on improving the pre-reading, prewriting, reading, writing, quantitative, social skills, and cognitive function of the Learners. In certain embodiments, the technology can be used as a supplemental tool for classroom instruction and take-home practice.

For example, in active usage, assuming on a given day, the teacher is focused on teaching alphabets. After the teacher is done teaching, through the administrative panel provided, the teacher can cast the alphabet lesson from a system as described herein to the television for all the children present to watch. When that is over, the teacher can then designate one (1) hour of personal learning, where all the children get to use the system on the tablets provided. In certain embodiments, once each child is done watching the alphabet sing-along, he/she is redirected to the practice section and shown the sky-view of a simple maze with all the alphabets scattered randomly across the maze. An audio instruction then plays, telling the child to pick up all the letters of the alphabets in the right order. The child can be allowed an additional 1 minute to look at the sky-view of the maze before the game starts. As the child tries to navigate through the maze to pick up the letters, fun obstacles are put randomly in his/her path, which must be avoided, thus making the process fun and very engaging for the child. If the child picks up all the letters but they are not in the right order, e.g., “DBCA” instead of “ABCD”, the system will count it as a failed attempt. In each practice session, the child will be given a maximum of three attempts, before he/she is redirected back to the lesson. The learning rate of the child can then be used to regulate the delivery speed of the lessons and focuses on the specific areas of difficulty where the child needs more help. All the while, the teacher is able to see through the administrative portal if all the children are actively doing their practice or not.

In certain embodiments, by combining educational animated cartoons with educational games which can be tailored to match the learning outcomes of the cartoons, in an adaptable medium, the technology can improve learning outcomes in early childhood education.

In certain embodiments, certain questions can be used in the quality assurance phase which can happen, pre-deployment, at test centers or during the testing period to possibly determine usability:
When program starts for the first time, does the on-boarding screen show?
Is the on-boarding process interactive?
Is the user profile populated as expected?
After the onboarding process is the user directed to the lesson and practice dashboard with the age appropriate level highlighted?
When the green start button is clicked, does the screen immediately redirect to the lesson? And does the lesson play?
When the lesson ends, does it immediately redirect to the game?
In the game section, are the instructions provided clearly with a demo walking the user through a sample game-play?
Does the system notify the teacher through the admin portal when a child is having difficulties following along in their demo play?

In certain embodiments, the technology can store the following data variables on a readable computer medium which in certain embodiments is a hybrid cloud storage:
User ID
Age
Center Name
Pre-test Learning Rate
Duration Spent Watching Lesson
Duration Spent in Game Play
Identified Problem
Number of Walks Through Path A
Number of Walks Through Path B
Number of Walks Through Path C
Game Play Errors
Game Play Latency
Learner Errors

User Classes and Characteristics: As used herein, “user” means any individual who uses a system herein in any aspect. Educational Users, such as pre-k Learners, either under the Supervision of an educator, their parent, guardian, or primary caregiver. Leisure Users: such as K12 students, college students, or adults, who want to utilize the software for fun. Supervisory Users: such as educators, parents, guardians or primary caregivers who have access to the admin dashboard to monitor the progress of their dependent.

As used herein, “Learner” or “subject” means, a user of the technology who is partaking in the educational portion of the system. In various embodiments, the Learner can be a child or an adult. In certain embodiments the Learner can be a child aged 6 to 10, or younger than 6, or older than 10.

As used herein, “Supervisor” or “Supervisory user” means a user of the technology who is overserving and managing one or more Learners partaking in the educational portion of the system. In various embodiments the Supervisor is an adult, aged 18 or older, such as a teacher, educator, or education administrator.

As used herein, “Initial Assessment” means a series of lessons and tests to determine a Learner's: Education Level, preferred Learning Style, Cognitive Quotient, or Learning Rate. In certain embodiments, this can function as follows:
Lessons: Pulls the Lessons( ) method from the Verbal-Lessons, Quant-Lessons, Social Lessons modules
Outcomes: Pulls the Outcomes( ) method from the Verbal-Lessons, Quant-Lessons, Social Lessons modules.
Questions: Pulls the Questions( ) method from the Verbal-Test, Quant-Test, Social-Test, and Disorders-Test modules
Styles: Pulls the Styles( ) method from the Style module.
LevelResult: Records determined educational level.
Randomize: Receives LevelResult( ). Randomly pairs lessons with Styles, calling the Equip( ) method to activate the style on the lesson.
Result: Stores test results.
Options: Displays all available tests, each equipped with a submit functionality.
Maze: Activates Maze module.

In certain embodiments, a method or system herein can include any of the following steps:
1. Activates the maze.
2. Displays all the test for the learner to choose which one he/she wants to start.
3. When a test is selected the associated module is called.
4. The learner does the test by completing assigned challenges in the maze
5. The determine educational level from the verbal, quant, social, and disorder tests is stored.
6. The determined level is used to randomly select lessons and activate a learning style per lesson.
7. The Leaner is made to watch the lessons three times before taking the test associated with the lesson.
8. The lesson-style pair with the highest test score is used to set the Learner's Preferred Learning Style.
9. The final results are stored. Ready to be used in setting the system.

As used herein, “Cognitive Quotient” means the cognitive recollection of the Learner based on their ability to navigate through the maze with respect to time. The formula for calculating the Cognitive Quotient is as follows:

$$Cognitive Quotient ( V ) = \frac{( \frac{1}{n} * ( {\sum }_{i = 1}^{n} T - ( {\sum }_{i = 1}^{n} B + {\sum }_{i = 1}^{n} D ) ) )}{L + ( \frac{t}{n} * ( {\sum }_{i = 1}^{n} P + {\sum }_{i = 1}^{n} E ) )}$$

Where:
T=time taken to complete the maze
n=Either 1, 2 or 3 inversely proportional to L
t=number of times the specific game level is attempted
D=time spent looking at the aerial view after the game starts
L=number of lives the player has at the end of the gameplay
B=time spent looking at the aerial view before the game starts
P=number of paths the player traversed more times than necessary
E=number of mistakes made in navigating the maze and solving the challenge

How it is calculated:
1. If L=0 then n=3, L=1 then n=2, L=2 then n=1
2. Based on the value of n, calculate the average values of T, B, D, P and E
3. Subtract the sum of the B and D averages from the T average to have the final numerator value.
4. Multiply the sum of the average values of P and E by t and add L to it to have the final denominator value.
5. Divide the numerator value by the denominator value to get the cognitive quotient.

As used herein, “Learning Rate” means the Learner's ability to understand and apply new concepts introduced with respect to time. The formula for calculating the Learning Rate is as follows:

$$Learning rate ( R ) = \frac{{e}^{\frac{X}{Y}}}{{e}^{\frac{X}{Y}} + 1} * V$$

Where:

$$X = \frac{1}{n} * ( {\sum }_{i = 1}^{n} T - {\sum }_{i = 1}^{n} q ) y = \frac{T}{n} * ( {\sum }_{i = 1}^{n} P + {\sum }_{i = 1}^{n} E )$$

V=Cognitive quotient
T=time taken to complete the maze
n=Either 1, 2 or 3 inversely proportional to L
P=number of paths the player traversed more times than necessary
q=total number of times each path is repeated more than necessary
E=number of mistakes made in navigating the maze and solving the challenge

How it is calculated:
1. If L=0 then n=3, L=1 then n=2, L=2 then n=1
2. Based on the value of n, calculate the average values of T, P, q, and E
3. Subtract the q average from the T average to have the final numerator value of the exponent function, denoted by X.
4. Sum the P and E averages and multiply by T to have the final denominator value of the exponent, denoted by Y.
5. Divide the X by Y and pass it the exponent function to get a resulting value.
6. Divide the resulting value by the sum of 1 and itself
7. Multiply the result by V to get the learning rate.

As used herein, “Preferred Learning Style” means the technique by which the content is delivered to the Learner and can be any one or more of the following: Touch, Speech, Written, Idle, Touch-Speech, Touch-Written, Speech-Written, Touch-Speech-Written.
Wherein Idle means the Learner progresses through the content without any form of interaction.
Wherein Speech means the Learner progresses through the content using their own voice.
Wherein Touch means the Learner progresses through the content using physical touch.
Wherein Written means the Learner progresses through the content using the written word.
Wherein Touch-Speech is a combination of the Touch and Speech Styles.
Wherein Touch-Written is a combination of the Touch and Written Styles.
Wherein Speech-Written is a combination of the Speech and Written Styles.
Wherein Touch-Speech-Written is a combination of the Touch, Speech, and Written Styles.

As used herein, “Educational Level” means the assessed educational grade of the Learner's intellectual muscle memory with respect to educational content.

### Drawings

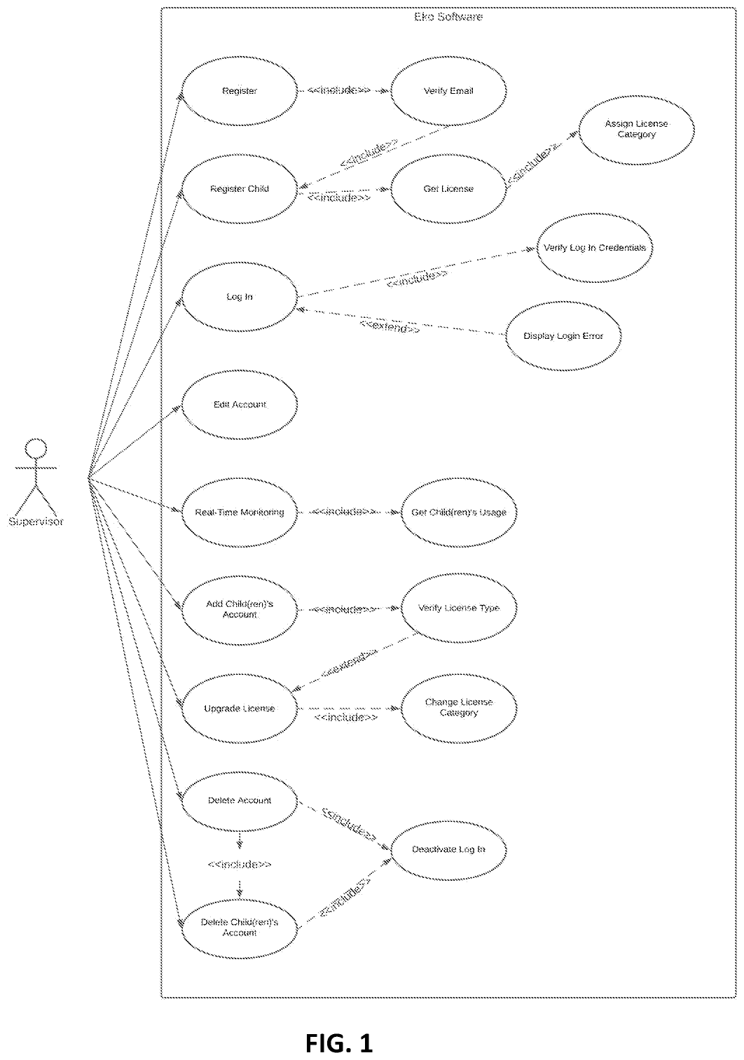

As shown in FIG. 1, in certain embodiments, the Supervisor can register themselves and verify their email, which allows them to in turn register a Learner. Once at least one Learner is registered, the Supervisor is assigned a license category. Once the Supervisor is assigned a license category, the Supervisor can log in a Supervisor account and the Supervisor's credentials are either verified or a login error is displayed. Once logged in, the Supervisor can edit the details of the Supervisor's account. The Supervisor can monitor in real time any assigned Learners usage. To add additional Learner accounts to their dashboard, Supervisors can verify the individual license category of the new Learners. The Supervisor can upgrade license categories by changing the license category. Supervisors can delete their own account wherein they also simultaneously delete each of their assigned Learner accounts; or alternatively can delete any one of their assigned Learner accounts, wherein the Supervisor's account will not be deleted.

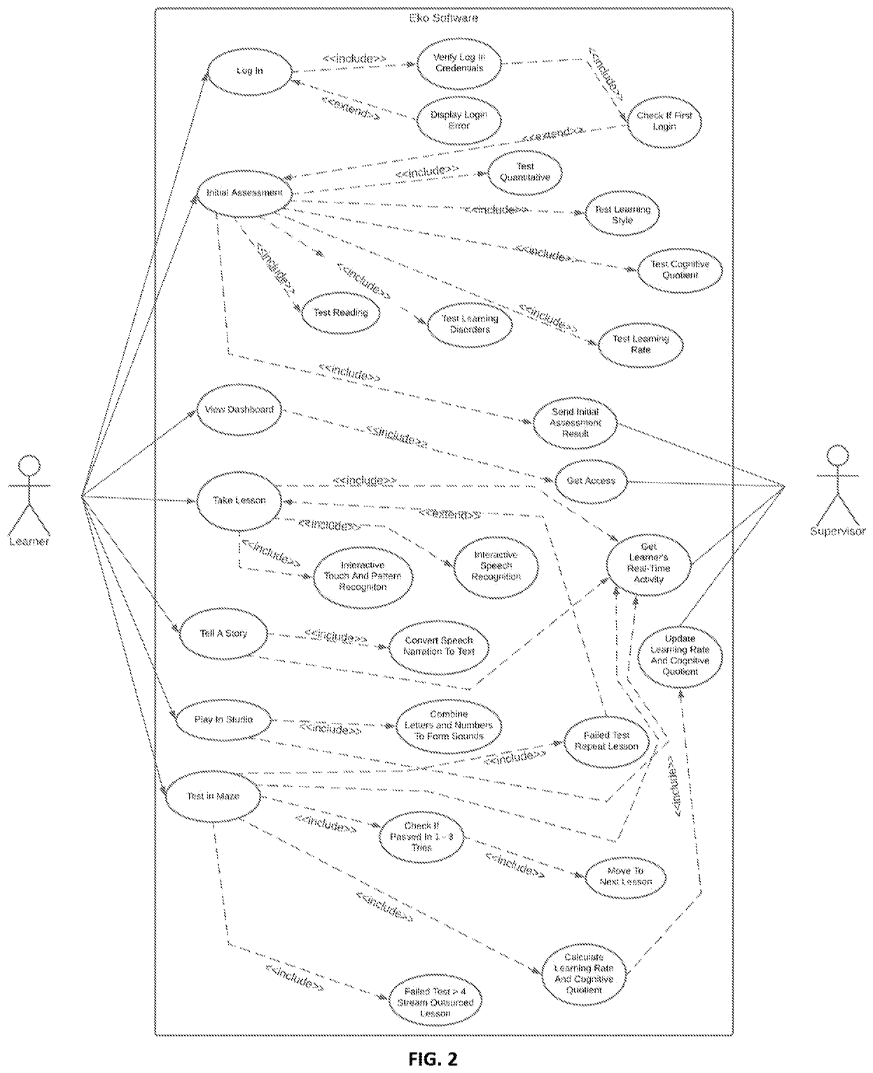

As shown in FIG. 2, in certain embodiments, the Learner can log in, take the Initial Assessment, and view their Dashboard. Upon logging in, the Software verifies the Learner's login credentials, if verified the Learner is redirected into the Learning Environment but if the verification fails a login error is displayed. If it is the Learner's first check-in or if the Learner had previously failed to complete the Initial Assessment, the Learner is directed to the Initial Assessment. After the Learner begins and then completes the Initial Assessment, the Learner can request access to the Dashboard from the Supervisor, and if the Supervisor grants access, the Learner can view the Dashboard. If the Supervisor does not grant access, the Learner will have access to the assigned learning path only. In this embodiment of the present technology the Learner can take a lesson and test in Maze. The Learner can take a lesson wherein the Learner can utilize the Interactive Touch and Pattern Recognition or the Interactive Speech Recognition. In certain embodiments, after taking a lesson, the Learner must test in the Maze. If the Learner fails the Maze, the Learner must retake the respective lesson related to the Maze test. If the Learner does not pass within three times, the Learner must retake the lesson. If the Learner fails on the fourth attempt, they must then stream an outsourced lesson. The data recorded from each Maze test can be used to calculate the Learner's Learning Rate and Cognitive Quotient, and the updated Learning Rate and Cognitive Quotient can be displayed to the Supervisor. Wherein the Learner's activity through the lessons and Maze is provided in real time to the Supervisor. In this embodiment of the present technology the Learner can use the “Tell A Story” and “Play In Studio” functions. When utilizing the “Tell A Story” function the Learner can convert Speech narration to text, and the activity is provided to the Supervisor in real time. For the “Play In Studio” function the Learner can combine letter and numbers to form sounds, and the activity is provided to the Supervisor in real time.

### Modules

In various embodiments, the technology herein can be organized in one or more of the following modules:

User Module:
License: Verifies users' license. Calls the License module.
Sign In: Existing users must sign in before he/she can use the software. Calls the Log-In module.
Sign Up: Collect user registration information if first-timer. Calls the Registration module.
Reset: The user can reset his/her password.
Delete: The users can choose to cancel the existing account. All personal data will be removed, and users will lose access to the account, but usage data will remain masked.
Profile: Stores user demographics and educational level. Onboarding questions filled by parents/guardians. Calls the Registration module.
Type: Users must select the type of account being created, if it's standard, leisure or supervisory.

License Module:
Type: Users select the type of account being created if it's leisure or supervisory.
Detect: On startup, automatically detect if software is running on a company or a third-party device. If it's the company's device, the license is automatically filled.
Subscription: Standard/Supervisory users must enter a purchased license or sign up for a subscription plan if running on a third-party device. Gives leisure users the option to use a free account.

Log-In Module:
Sign-In: Allows the user to sign in if being accessed from a third-party device.
Verify: Checks that the user exists
First: Checks if it is the users first sign-in after registration and prompts to add dependent.
Sign-Out: Allows the user to log out of the program if being accessed from a third-party device.

Plan Module:
Plans: Allows users to select from subscription plan options.
Purchase: Allows users to pay for plans.
Upgrade: Allows users to upgrade their accounts.

Registration Module:
Plans: Displays subscription plan options.
Purchase: Allows users to pay for plans
Form: Displays mandatory registration form by calling the Form module.
Verify: Makes individual verify email and identity.
Dependent: Upon verification, prompts individual to add a dependent before account can be fully activated.

Dependents Module:
Form: Displays mandatory registration form by calling the Form module.
Verify: Makes individual verify email and identity of the dependent
Photo: Allows upload of passport photograph.

Form Module:
FirstName:
MiddleName:
LastName:
Age:
Gender:
Nationality
CountryofResidence:
StateofResidence:
CityofResidence:
Edu-Level:

Content Module:
Level: Displays user's current level.
Lesson: Displays all the animated lesson modules for all users except leisure users. Makes all the methods in the Lesson module accessible for functionality of the system in relation the learner's level.
Curate: Displays all curated content per level if the user hasn't been promoted after 3 lesson-practice cycles.
Test: Displays each test lesson modules for all users except leisure users. Makes all the methods in the Testing module accessible for functionality of the system in relation the learner's level.
Practice: Pulls all the animated practice content associated with each completed lesson from the Practice module.
Learn: Makes all the methods in the Learn module accessible for functionality of the system in relation the learner's level.

Learn Module:
Onboarding: Runs Initial Assessment module on the user to determine his/her learning style, rate and needs.
Initial-Set: Uses the returned value from the Onboarding( ) method to set the initial content of the user.
Rates: Pulls and stores the user's learning rate during each test session.
Update: Calculates and records an aggregate of the user's learning rate quarterly.
Agile: Adjusts the content delivery to users based on their Rate.
Promote: Allows users to progress to the next content level if learning outcomes of the current content level are met. Automatically update the user's level.
Source: Curates open-source content to supplement lesson content of the standard users based on their needs.
Cog: Pulls and stores the user's cognitive quotient during each test session.

Initial Assessment Module:
Lessons: Pulls the Lessons( ) method from the Verbal-Lessons, Quant-Lessons, Social Lessons modules.
Outcomes: Pulls the Outcomes( ) method from the Verbal-Lessons, Quant-Lessons, Social Lessons modules.
Questions: Pulls the Questions( ) method from the Verbal-Test, Quant-Test, Social-Test, and Disorders-Test modules
Styles: Pulls the Styles( ) method from the Style module.
LevelResult: Records determined educational level.
Randomize: Receives LevelResult( ). Randomly pairs lessons with Styles, calling the Equip( ) method to activate the style on the lesson.
Result: Stores test results.
Options: Displays all available tests, each equipped with a submit functionality.
Maze: Activates Maze module.

In Certain Embodiments, the Initial Assessment Module Includes One or More of the Following Steps:
1. Activates the maze.
2. Displays all the test for the Learner to choose which one he/she wants to start.
3. When a test is selected the associated module is called.
4. The Learner does the test by completing assigned challenges in the maze
5. The determine educational level from the verbal, quant, social, and disorder tests is stored.
6. The determined level is used to randomly select lessons and activate a learning style per lesson.
7. The Learner is made to watch the lessons three times before taking the test associated with the lesson.
8. The lesson-style pair with the highest test score is used to set the Learner's preferred learning style.
9. The final results are stored. Ready to be used in setting the system.

Style Module:
Styles: Stores a list of learning styles. Touch, Speech, Written, Idle, Touch-Speech, Touch-Written, Speech-Written, TSW.
Equip: Receives lesson Id and Style. Turns on the style in the associated lesson.
Rating: Stores hashmap of each style and its effectiveness rating per dependents.

Lesson Module:
Home: Pulls the Lessons( ) method from the Verbal-Lessons, Quant-Lessons, Social Lessons modules and then displays each lesson category and the number of lessons in the category.
Learning-Path: Displays the current lesson category and its associated learning path that the Learner is on.
Start: Allows Learners to start their assigned lesson.
Timer: Tracks the total time spent watching each lesson.
Expectations: Pulls the Expectation( ) method from the Verbal-Lessons, Quant-Lessons, Social Lessons modules.
Outcomes: Pulls the Outcomes( ) method from the Verbal-Lessons, Quant-Lessons, Social Lessons modules.

Verbal-Lessons Module:
Lessons: Pulls all verbal lessons from database.
Outcomes: Pulls all associated learning outcomes from database.
Expectation: Stores lesson questions and answers.
Refresh: Checks for updates and reloads the Lessons( ) and Outcomes( ) methods when necessary.

Quant-Lessons Module:
Lessons: Pulls all quantitative lessons from database.
Outcomes: Pulls all associated learning outcomes from database.
Expectation: Stores lesson questions and answers.
Refresh: Checks for updates and reloads the Lessons( ) and Outcomes( ) methods when necessary.

Social-Lessons Module:
Lessons: Pulls all social lessons from database.
Expectation: Stores lesson questions and answers.
Outcomes: Pulls all associated learning outcomes from database.
Refresh: Checks for updates and reloads the Lessons( ) and Outcomes( ) methods when necessary.

Practice Module:
Home: Pulls the practice content from the database associated to the Learner's lesson level and then displays each practice category and the number of practice simulations in the category.
Disorders: Makes the Disorders-Test Module accessible during testing.
Learning-Path: Displays the practice category and its associated learning path that the Learner is on.
Start: Allows Learners to start their assigned practice.
Timer: Tracks the total time spent taking each lesson practice.
Expectations: Pulls the Expectation( ) method from the Lesson module.
Outcomes: Pulls the Outcomes( ) method from the Lesson module.

Testing Module:
Home: Pulls the Questions( ) method from the Verbal-Test, Quant-Test, Social-Test modules and then displays each test category and the number of tests in the category.
Disorders: Makes the Disorders-Test Module accessible during testing.
Learning-Path: Displays the test category and its associated learning path that the Learner is on.
Start: Allows Learners to start their assigned test.
Timer: Tracks the total time spent taking each test.
Expectations: Pulls the Expectation( ) method from the Lesson module.
Outcomes: Pulls the Outcomes( ) method from the Lesson module.

Verbal-Test Module:
Questions: Pulls verbal questions from database.
Refresh: Checks for updates and reloads the Questions( ) method when necessary.

In Certain Embodiments, the Verbal-Test Module Includes One or More of the Following Steps:
1. When activated, within the maze game, the Learner is expected to complete all verbal tasks.
2. For example, if the task is to pick all the letters in the alphabet, the maze will be switched to first person mode.
3. As the Learner navigates through the maze, he/she is expected to pick the letters in order from A-Z.
4. Each letter character is equipped with a proximity sensor that enables pick now or pick later prompt when the Learner's first-person character is close.
5. If the Learner picks the letters in the wrong order, he/she fails the test and is given to more opportunities to try.
6. Points are awarded based on pick accuracy.

Disorders-Test Module:
Questions: Pulls all disorder symptomatic questions from curated opensource medical data
Track: Enables counter for each symptom in the Questions( ) method, and increments by 1 each time the symptom is identified, and 0 when it isn't.
Check: Assigns True or False to symptom if the Track( ) method returns a value of at least 3.
Validate: Compares the result from check against expected number of symptoms per disorder. Percentage expectancy.
Refresh: Checks for updates and reloads the Questions( ) method when necessary.

In Certain Embodiments, the Disorders-Test Module Includes One or More of the Following Steps:
1. During the interactive lessons and tests, based on responses from the Learner the tracker runs.
2. For any symptom that has been identified at least 3 times, it is recorded as a valid symptom.
3. The identified symptoms are compared with the medical standard evaluation, and if the identified symptoms satisfy 70% of the expectancy the disorder is recorded as “present tentative”.
4. Each time the Learner uses the system the test is conducted in the background and the percentage expectancy is updated.
5. If the expectancy is 90% and above, the disorder record is updated to present.

Quant-Test Module:
Questions: Pulls quantitative questions from database.
Refresh: Checks for updates and reloads the Questions( ) method when necessary.

In Certain Embodiments, the Quant-Test Module Includes One or More of the Following Steps:
1. When activated, within the maze game, the Learner is expected to complete all verbal tasks.
2. For example, if the task is to pick all the unit digits from 0 to 9 in the number scale, the maze will be switched to first person mode.
3. As the Learner navigates through the maze, he/she is expected to pick the letters in order from 0-9.
4. Each number character is equipped with a proximity sensor that enables pick now or pick later prompt when the Learner's first-person character is close.
5. If the Learner picks the numbers in the wrong order, he/she fails the test and is given to more opportunities to try.
6. Points are awarded based on pick accuracy.

Social-Test Module:
Task: Pulls social tasks from database.
Refresh: Checks for updates and reloads the Questions( ) method when necessary.

In Certain Embodiments, the Social-Test Module Includes One or More of the Following Steps:
1. When activated, within the maze game, the Learner is expected to complete all social interaction tasks.
2. For example, if the task is to talk with 4 characters, the maze will be switched to first-person mode and as the Learner navigates through the maze, he/she is expected to either respond to a greeting from the animated character, or initiate a conversation.
3. Each character is equipped with a proximity sensor that enables it to react the Learner's first-person character is close.
4. As the Learner speaks, the speech is received, and the game character responds in real-time.
5. Points are awarded based on the level of communication.
6. If the Learner passes the first level, it moves keeps testing at higher levels until a level isn't passed.

Maze Module:
Build: Calls the Initial-Set( ), Rates( ) and Cog( ) methods from the Learn module and if it is the first time, it uses the parameters to set the complexity of the maze as it builds it.
Auto: Adjusts the complexity of the maze based on the Rate( ) and Cognitive( ) methods.
Options: Displays 4 options to the Learner (‘Take Test Now’, ‘Re-Watch Lesson’, ‘Practice In Play Studio’, ‘Try Telling A Story’).
Challenge: Randomly place obstacles and interactive objects in the maze based on the user's content level.
Ordered: Tracks the order in which Learners interact with each task object. Returns true or false.
Aerial: Displays the aerial view of the maze to the user (standard and leisure) for specified time (default: 60 seconds).
Pinpoint: Tracks concepts in the learning outcome where the Learner has difficulties.
Before: Tracks the time spent looking at the aerial view of the maze at the start of the game. Contains 3-time variables.
During: Tracks the time spent looking at the aerial view of the maze while playing the game. Contains 3-time variables.
Time: Tracks the time taken to complete the maze during each play and adds it to the pulled time from the Timer( ) methods in both the Lesson and Practice modules. Contains 3-time variables.
Path-time: Tracks the total number of times each path is repeated more than necessary. Contains 3-time variables.
Path: Tracks the number of paths the player traversed more times than necessary. Contains 3-Path variables.
Start: Commences a countdown from 10 seconds and begins the game when it gets to 0. Provides user opportunity to pause game. Displays option to show aerial view while game is paused.
End: Terminates game play if the user finishes the assigned task in the wrong order 3 times. Displays option to watch lesson again or play game again.
Errors: Tracks the all the mistakes made in navigating the maze and solving the challenge within the maze. Contains 3-Error variables.
Lives: Tracks the number of lives the player has at the end of the gameplay.
Tries: Tracks the number of times the specific game level is attempted. Redirect to Lesson module at 4 tries.
Rate: Calls the Learning-Rate module.
Cognitive: Calls the Cognitive-Quotient module.
Lesson: Pulls the test from the Content module, and places it randomly in the maze. Text to speech enabled, in relaying the task instruction.
Hint: Calls the Aerial( ) method.
Promote: Calls the Promote( ) method in the Learn module.
Groups: Activates the maze in group mode.

In Certain Embodiments, the Maze Module Includes One or More of the Following Steps:
1. At the end of each lesson, the Learner is redirected to the maze and a popup appears in the middle with 4 options for the learner to choose from. (‘Take Test Now’, ‘Re-Watch Lesson’, ‘Practice In Play Studio’, ‘Try Telling A Story’)
2. If the Learner clicks on any other option apart from the ‘Take Test Now ’ option, then the user is redirected out of the maze to the page for that option.
3. When the Learner clicks on the ‘Take Test Now’ option, the Build( ) method called and if it is the first time the user is playing on that level, the complexity of the maze is built according to the parameters from the Initial-Set( ) method. Else it uses the prior parameters stored by the Rates( ) and Cog( ) methods to set the complexity of the maze.
4. With the maze generated, the Lesson( ) method is activated and it calls the Test( ) method from the Content module, displaying the written out task and randomly places the task in the form of 3D static-mesh instances within the maze. Once instances are in place, the Lesson( ) method reads the task aloud.
5. At the end of the reading by the Lesson( ) method, the Aerial( ) method is activated, displaying the aerial view of the maze for the default timeframe, highlighting the positions of all task instances.
6. When the aerial view times out, the Start( ) method is called, dropping the Learner's first-person character into the 3D maze and displays a countdown for the user.
7. The Lives( ) method displays 2 hearts to signify 2 lives left at the top right corner of the screen once the learner starts playing.
8. Next to the “lives display”, is the a “Hint” icon that calls the activates the Hint( ) method when clicked, pauses the game and displays the aerial view of the maze.
9. If the Learner fails the task for that level, the “lives display” declines by 1 and he/she has to repeat the level.
10. During game play, all the types of errors made by the Learner are tracked by the pinpoint method, segmenting them into clusters based on keywords.
11. If there are no lives left and the task has not been completed, the Learner is redirected to the lesson.
12. If upon completion of the lesson, the Learner fails his/her fourth attempt at completing the task, the “Tries” method automatically redirects the Leaner to his/her content homepage.
13. If the Learner is successful at completing the task, it triggers the Promote( ) method resulting in the learner's progress to the next level.

Player-Lives Module:
Lives: Returns the number of tried the user has during a maze session. Default value is 2.
Less: If the Learner fails the maze play, it subtracts 1 from the Lives and updates it with the new value.
Ordered: Pulls the return value from the Ordered( ) method of the Maze module.
Reset: The Lives is reset to its default value. In the case of leisure users, if the leisure user presses the button, and it requires the user's account to be equipped through an in-app purchase. In the case of Learners, it is only activated automatically when the Learner fails the 3 attempts and has re-watched the associated lesson.
Re-Watched: Returns True or False to the Reset( ) method. Default value is False.

In Certain Embodiments, the Player Lives Module Includes One or More of the Following Steps:
1. When the game starts, it displays 2 hearts to signify 2 lives left at the top right corner of the screen.
2. On the back-end it possess an in-built counter tied to each gameplay per lesson session.
3. If the ordered value returned is “true” the lives value remains unchanged.
4. If the ordered value returned is “false” the lives value is decremented by 1.

Cognitive-Quotient Module: This module measures and stores the cognitive recollection of the Learner based on his/her ability to navigate through the maze with respect to time.
Before: Pulls the time spent looking at the aerial view of the maze at the start of the game from the Maze module. Contains 3-time variables.
During: Pulls the time spent looking at the aerial view of the maze while playing the game from the Maze module. Contains 3-time variables.
Time: Pulls the time taken to complete the maze during each play from the Maze module. Contains 3-time variables.
Path: Pulls the number of paths the player traversed more times than necessary from the Maze module. Contains 3-Path variables.
Errors: Pulls the all the mistakes made in navigating the maze and solving the challenge within the maze from the Maze module. Contains 3-Error variables.
Lives: Pulls the number of lives the player has at the end of the gameplay from the Maze module.
Tries: Pulls the number of times the specific game level is attempted from the Maze module.
Value: Calculates and returns the cognitive quotient.

The formula for calculating the cognitive quotient is as follows:

$$Cognitive Quotient ( V ) = \frac{( \frac{1}{n} * ( {\sum }_{i = 1}^{n} T - ( {\sum }_{i = 1}^{n} B + {\sum }_{i = 1}^{n} D ) ) )}{L + ( \frac{t}{n} * ( {\sum }_{i = 1}^{n} P + {\sum }_{i = 1}^{n} E ) )}$$

Where:
T=time taken to complete the maze
n=Either 1, 2 or 3 inversely proportional to L
t=number of times the specific game level is attempted
D=time spent looking at the aerial view after the game starts
L=number of lives the player has at the end of the gameplay
B=time spent looking at the aerial view before the game starts
P=number of paths the player traversed more times than necessary
E=number of mistakes made in navigating the maze and solving the challenge

How the Cognitive Quotient is Calculated:
6. If L=0 then n=3, L=1 then n=2, L=2 then n=1
7. Based on the value of n, calculate the average values of T, B, D, P and E
8. Subtract the sum of the B and D averages from the T average to have the final numerator value.
9. Multiply the sum of the average values of P and E by t and add L to it to have the final denominator value.
10. Divide the numerator value by the denominator value to get the cognitive quotient.

Learning-Rate Module: This module measures and stores the user's ability to understand and apply new concepts introduced with respect to time.
Value: Pulls the cognitive quotient value from the Value( ) method of the Cognitive-Quotient module.
Time: Pulls the time taken to complete the maze during each play from the Maze module. Contains 3-time variables.
Path-time: Pulls the total number of times each path is repeated more than necessary from the Maze module. Contains 3-time variables.
Path: Pulls the number of paths the player traversed more times than necessary from the Maze module. Contains 3-Path variables.
Errors: Pulls the all the mistakes made in navigating the maze and solving the challenge within the maze from the Maze module. Contains 3-Error variables.
Lives: Pulls the number of lives the player has at the end of the gameplay from the Maze module.

The formula for calculating the learning rate is as follows:

$$Learning rate ( R ) = \frac{{e}^{\frac{X}{Y}}}{{e}^{\frac{X}{Y}} + 1} * V$$

Where:

$$X = \frac{1}{n} * ( {\sum }_{i = 1}^{n} T - {\sum }_{i = 1}^{n} q ) y = \frac{T}{n} * ( {\sum }_{i = 1}^{n} P + {\sum }_{i = 1}^{n} E )$$

V=Cognitive quotient
T=time taken to complete the maze
n=Either 1, 2 or 3 inversely proportional to L
P=number of paths the player traversed more times than necessary
q=total number of times each path is repeated more than necessary
E=number of mistakes made in navigating the maze and solving the challenge

How the Learning Rate is Calculated:
8. If L=0 then n=3, L=1 then n=2, L=2 then n=1
9. Based on the value of n, calculate the average values of T, P, q, and E
10. Subtract the q average from the T average to have the final numerator value of the exponent function, denoted by X.
11. Sum the P and E averages and multiply by T to have the final denominator value of the exponent, denoted by Y.
12. Divide the X by Y and pass it the exponent function to get a resulting value.
13. Divide the resulting value by the sum of 1 and itself.
14. Multiply the result by V to get the learning rate.

Group Module: This enables the dependents to participate in virtual and in-person group activities
maze: Calls the Maze module.
Activity: Displays to the supervisor all the game activities their dependents can collectively engage in within the maze.
Groups: Allows the supervisor to determine the number of groups for each activity.
Hunt: Calls the Scavenger-Hunt module into the maze.
Builder: Calls the Lego-Builder module into the maze
Recycle: Calls the Recycler module into the maze.
Farmer: Calls the Animal-Farm module into the maze
Task: Displays assigned tasks to each group.
Decision: Collects the return value of the Assess( ) method from the Hunt( ), Builder( ), Recycle( ), and Farmer( ) methods to decide the winning group.
In-person: Pops up in-person actions that learners must do with themselves depending on the lesson and accepts video and pictures as evidence.
Cast: When activated, enables the supervisor to see a live view of the groups as they perform their activities.

In Certain Embodiments, the Group Module Includes One or More of the Following Steps:
1. The Supervisor clicks the “create group activity” button, the Groups( ) method is called, prompting him/her to select the number of groups to be created.
2. Next the Activity method is activated, prompting the user to select from the list of activities (Scavenger Hunt, Lego Builder, Recycler, Animal Farm, note more activities will be added).
3. Depending of the activity selected, it's corresponding module called, passing it and a dictionary of lists containing all dependents randomly assigned to groups.
4. On the dependents end they'll each receive a pop-up notification to join their group activity.
5. Accepting the popup will redirect them to the group maze.
6. At the end of each activity the Decision( ) method pulls the results of each group in the session from activities module to determine the winning

Tell-A-Story Module:
Record: Captures the Learner's narration.
Speak: Passes the narration from the Record method to the Speech-to-Text module for processing.
Avatar: Generates a 2D version of the Learner based on their user profile picture.
Animate: Pulls character from the Avatar( ) method and creates a 2D animation of the narration with captions.
Words: Stores the resulting text from the Speak( ) method.

In Certain Embodiments, the Tell-A-Story Module Includes One or More of the Following Steps:
1. When the “Tell A Story” button is clicked by the Learner, it opens a visual studio.
2. As the learner speaks, a 2D character of the is auto generated, and along with the existing characters in the system, the Learner's story is brought to life.
3. Captions are also generated and displayed in the form of subtitles for the Learner to visualize.

Play-In-Studio Module:
Compose: Displays all the letters of the alphabets, and numbers from 0 to 9 for the Learner to form numbers, words, and sentences.
Aloud: Reads the formed numbers, words, and sentences back to the Learner.
Story: Pulls content from the Words( ) method in the Tell-A-Story module for the Learner to manipulate the sounds.
Lesson: Lets Learners practice concepts from the lesson. Pulls from
Prompt: Asks the Learner if ready to take test if not taken. Default interval 15 minutes.

In Certain Embodiments, the Play-In-Studio Module Includes One or More of the Following Steps:
1. When the “Play In Studio” button is clicked by the Learner, it opens a sound studio.
2. The learner is given 3 options; Compose Sounds, Practice Lesson.
3. If Compose Sounds is clicked, the learner can either form random words and numbers or use the “Story” button to form new words using its content.
4. The Aloud method is called each time a word, number or sentence is formed, giving sound to the Learner's formulation.
5. If Practice Lesson is clicked, the Learner gets to practice all the concepts from the lesson.
6. Every 15 minutes, the Learner is given a prompt to start the maze game test if it has not yet been completed.

Scavenger-Hunt Module:
Treasures: Generates random bedazzled items.
Clues: Hides bedazzled objects around the maze and generates clues.
Fixtures: Generates random scene objects.
PickUp: Tracks as bedazzled items are found and picked by Learners.
Tasks: Pulls group activities from database
Assign: Randomly assigns tasks to each group.
Assess: Compares PickUp( ) with Tasks( ).
Timer: Prompts the supervisor to set the activity duration. Default value is 30 minutes.

In Certain Embodiments, the Scavenger-Hunt Module Includes One or More of the Following Steps:
1. When activated, the tasks are pulled from the database.
2. Based on the tasks pulled, the Treasures( ), Clues( ), and Fixtures( ) methods work synchronously to transform the maze into a treasure throve.
3. Based on the number of groups in the Group Module, the Assign( ) method assigns a treasure hunt task to the group.
4. When the maze starts, as each group navigates through, they need to use the provided clues to find the hidden treasures.
5. The PickUp( ) synchronously records each treasure discovered and picked up by each group.
6. The Timer( ) prompts the supervisor to set the activity duration and initiates a countdown from the set time immediately the activity starts.
7. Whether the assigned task has been completed or not, the activity ends immediately when the timer gets to 0.
8. At the end of the activity, the Assess( ) method compares PickUp( ) with Tasks( ), and stores the result as a return value that will be used in determining the winning team.

Block-Builder Module:
Blocks: Generates random blocks, for example interlocking blocks of bricks such as those available under the tradename Lego®.
Build: Pulls assigned task images of structures from Assign( ).
Tasks: Pulls group activities from database.
Snap: Takes a snapshot of the block structure once the timer stops.
Assign: Randomly assigns tasks to each group.
Assess: Compares Snap( ) with Build( ).
Timer: Prompts the supervisor to set the activity duration. Default value is 30 minutes.

In Certain Embodiments, the Blocker-Builder Module Includes One or More of the Following Steps:
1. When activated, the tasks are pulled from the database and based on the tasks pulled, the Blocks( ) methods generates the relevant 3D Lego-like blocks.
2. Based on the number of groups in the Group Module, the Assign( ) method assigns a building task to each group.
3. The Build( ) method places the relevant blocks in each maze room based on the task images pulled from the Assign( ) method, in relation to the group it has been assigned to.
4. The Timer( ) prompts the supervisor to set the activity duration and initiates a countdown from the set time immediately the activity starts.
5. When the maze starts, as each group navigates through to their respective rooms, and use the provided image as the blueprint to construct the assigned structure.
6. The Snap( ) takes a snapshot of the Lego structure once the timer stops.
7. Whether the assigned task has been completed or not, the activity ends immediately the timers gets to 0.
8. At the end of the activity, the Assess( ) method compares Snap( ) with Build( ), using the Image-Recognition module, and stores the result as a return value that will be used in determining the winning team.

Recycler Module:
Recyclables: Generates items that can either be recycled or trashed.
Dumpsites: Generates labeled trash cans.
Dump: Tracks as items are found, picked, and dumped by learners.
Prompts: Gives hints on trash types when an item is picked.
Tasks: Pulls group activities from database.
Assign: Randomly assigns tasks to each group.
Assess: Compares Dump( ) with Tasks( ).
Timer: Prompts the supervisor to set the activity duration. Default value is 30 minutes.

In Certain Embodiments, the Recycler Module Includes One or More of the Following Steps:
1. When activated, the task is pulled from the database
2. Based on the tasks pulled, the Recyclables( ), and Dumpsites( ) methods work synchronously to transform the maze into a junk yard.
3. Based on the number of groups in the Group Module, the Assign( ) method assigns a recycling task to each group, where they must put each type of trash in the right bin.
4. The Timer( ) prompts the Supervisor to set the activity duration and initiates a countdown from the set time immediately the activity starts.
5. When the maze starts, as each group navigates through, they need to use the provided prompts provided to appropriately trash items.
6. The Dump( ) synchronously records each item picked up and trashed by each group.
7. Whether the assigned task has been completed or not, the activity ends immediately the timers gets to 0.
8. At the end of the activity, the Assess( ) method compares Dump( ) with Tasks( ), and stores the result as a return value that will be used in determining the winning team.

Animal-Farm Module:
Animals: Generates 3D farm animals.
Equipment: Generates 3D farm equipment.
Farm: Transforms maze into a farm.
Work: Tracks each task item.
Tasks: Pulls group activities from database
Assign: Randomly assigns tasks to each group.
Assess: Compares Work( ) with Tasks( ).
Timer: Prompts the supervisor to set the activity duration. Default value is 30 minutes.

In Certain Embodiments, the Animal Farm Module Includes One or More of the Following Steps:
1. When activated, the task is pulled from the database
2. Based on the tasks pulled, the Animals( ), Equipment( ), and Farm( ) methods work synchronously to transform the maze into an animal farm.
3. Based on the number of groups in the Group Module, the Assign( ) method assigns a farm task to each group, where they are tasked with things like bathing dogs, feeding chickens.
4. The Timer( ) prompts the supervisor to set the activity duration and initiates a countdown from the set time immediately the activity starts.
5. When the maze starts, as each group navigates through, to the respective rooms to complete the task.
6. The Work( ) synchronously records as each group interacts with their activity items.
7. Whether the assigned task has been completed or not, the activity ends immediately the timers gets to 0.
8. At the end of the activity, the Assess( ) method compares Work( ) with Tasks( ), and stores the result as a return value that will be used in determining the winning team.

Monitored-Live Module:
Stream: Records in-classroom live activity.
Tasks: Pulls a group activity from the database.
Demo: Allows the supervisor to play a demo video for the learners.
Start: Begins the timer and stream.
Assess: Compares Stream( ) with Tasks( ).
Points: Awards points.
Timer: Prompts the Supervisor to set the activity duration. Default value is 30 minutes.

In Certain Embodiments, the Monitored-Live Module Includes One or More of the Following Steps:
1. When activated, the task is pulled from the database which the Supervisor must read to the Learners.
2. The Supervisor has the option to play the demo for the Learners to understand the activity better.
3. The Timer( ) prompts the Supervisor to set the activity duration and initiates a countdown from the set time immediately the activity starts.
4. The once the Supervisor presses the start button, the stream begins to record as the timer counts down.
5. Whether the assigned task has been completed or not, the activity ends immediately, when the timer gets to 0.
6. At the end of the activity, the Assess( ) method compares Stream( ) with Tasks( ), and stores the result as a return value that will be used in determining points awarded.

Touch-Recognition Module:
Touched: Sends feedback on lesson feature that was either touched or clicked.
Prompts: Pulls the interactive lesson prompts from the Lesson module
Expectation: Pulls the Expectations( ) method from the Lesson module.
Assess: Receives the feedback from the Touched( ) method and compares it to expected response from the Expectation( ) method.

In Certain Embodiments, the Initial Assessment Module Includes One or More of the Following Steps:
1. When activated in a lesson, the Learner gets voice prompts from the Prompts( ) method to touch the accurate display.
2. For instance, in a lesson about numbers, the Learner may be asked to touch number “6”.
3. Each touchable object is equipped with the functionality of a button so base on what was clicked the Touched( ) method receives and stores the feedback.
4. The Assess( ) method then compares the feedback in the Touched( ) method with the stored accurate response in the Expectation( ) method.

Speech-Recognition Module:
Listen: Captures verbal responses from the Learner.
Prompts: Pulls the interactive lesson prompts from the Lesson module
Expectation: Pulls the Expectations( ) method from the Lesson module.
Assess: Receives the feedback from the Listen( ) method and compares it to expected response from the Expectation( ) method.

In Certain Embodiments, the Speech Recognition Module Includes One or More of the Following Steps:
1. When activated in a lesson, the Listen( ) method records whatever sound and speech from the learner to learn to understand his/her verbal responses.
2. The Learner gets voice prompts from the Prompts( ) method to verbally answer a question.
3. For instance, in a lesson about alphabets, the Learner maybe asked to say what letter comes immediately after the letter “C”.
4. As the learner responds, the Listen( ) method receives and stores the feedback.
5. The Assess( ) method then compares the feedback in the Listen( ) method with the stored accurate response in the Expectation( ) method.

Written-Pattern-Recognition Module:
Write: Captures written responses from the Learner.
Slate: Displays a blackboard where the Learner is expected to write responses.
Prompts: Pulls the interactive lesson prompts from the Lesson module
Expectation: Pulls the Expectations( ) method from the Lesson module.
Assess: Receives the feedback from the Write( ) method and compares it to expected response from the Expectation( ) method.

In Certain Embodiments, the Written-Pattern-Recognition Module Includes One or More of the Following Steps:
1. When activated in a lesson, Slate( ) method displays the blackboard, allowing the Learner write on it while taking the lesson allowing the system to learn his/her handwriting.
2. The Learner gets voice prompts from the Prompts( ) method to write the answer to a question.
3. For instance, in a lesson about numbers, the Learner maybe asked to touch number “6”.
4. The Write( ) method receives and stores the written feedback.
5. The Assess( ) method then compares the feedback in the Write( ) method with the stored accurate response in the Expectation( ) method.

Speech-to-Text Module:
Speech: Captures verbal responses from the Learner.
Text: Converts the speech to written words.
Display: Shows text as captions.

In Certain Embodiments, the Speech-to-Text Module Includes One or More of the Following Steps:
1. When activated in a lesson, all the Learner's speech are captured and converted to readable text.

Deep-Reinforced-Learning Module:
Enables the animated character to hold conversations with the Learner in within the Social-Test module, and also in improving the way the system recognizes the speech and writing pattern of any learner globally.

Image Recognition Module:
Uses leading industry-standard image recognition models typically found in computer vision products to identify if images match within the Group Module.

In-App Purchases Module:
Powerpacks: Displays all available power packs and their price to the leisure user only.
Purchase: Allows leisure users to make a power pack purchase.
Promotion: Displays promotional offers to leisure users and applies appropriate discounts to their accounts at checkout.

Dashboard Module:
Overview: Displays the usage and progress statistics charts of the user. If it's a standard user, the overview is shown on the corresponding supervisory user's dashboard.
Progress: Displays the learning path of the standard user or leisure user, with the completed content indicated. The strengths and weaknesses of the user will be indicated.
Overwatch: Displays the results of the Summary( ) method from the Overwatch module to the Supervisor and gives them access to other functionalities of the module.
Group: Gives the Supervisor access to the Group module, allowing them to assign group tasks to their dependents.
Access: If the dependent tries to access the dashboard, the method sends a notification to the Supervisor requesting access. Status Default: False. Supervisor can change default to True.
Dependent: Receives “Status” from the Access( ) method. If the value is True, then the learner is granted access to the Dash method.

Dash Module:
Practice: Displays the “Play In Studio” icon button on the Learners' dashboard.
Story: Displays the “Tell A Story” icon button on the Learners' dashboard.
LearningContent: Pulls and displays all functionalities of the Content module.

In Certain Embodiments, the Dash Module Includes One or More of the Following Steps:
1. When activated by the Supervisor, it replaces the Content module display with a new dashboard display that shows everything in the Content module.
2. More importantly it provided the Learner with visible access to the Play-In-Studio and Tell-A-Story modules which are otherwise inaccessible.

Overview Module:
Appearance: Here the Supervisory user can change the color of each ward's charts. He/she can choose one color for all the edges/nodes/lines/bars or choose multiple colors, according to the values of a certain attribute.
Layout: Here the Supervisory user can change the type of chart by using one of the available chart layouts.
Statistics: Here the Supervisory user can choose which of the chart statistics will be calculated (by pressing on the button “Run” of the desired statistic).

Stats Module:
Track: Here the completed content is tracked along with the duration taken to complete.
Chart: Generates line/bar/pie charts of data stored by the Track and Update sub-functions.

Overwatch Module:
Summary: Gives the Supervisory user an overview of the real-time activity of all Learners registered to them, if idle, active, and learning pain-point.
Zone: Gives the supervisory user the ability to view the screens of up to 1 to 6 Learners at a time, depending on license type.

In Certain Embodiments, the Overwatch Module Includes One or More of the Following Steps:
1. On the Supervisory user's dashboard, he/she clicks on the overwatch button.
2. When clicked, it will redirect to a new dashboard showing all the dependents on the account, with information like—online/offline status, active/idle status, a displayed list of learning pain-points, percentage of assigned work's progress, and the zone button.
3. When the zone button is clicked, the supervisor is given view access of the dependents screen, enabling him/her to view the real-time activity of the dependent.

Help Module:
Check for Updates: Displays the available updates to newer versions if any.
About: Displays the logo of Naina Tech, which licenses are being used, the product version and other info.
Contact: Allows users (leisure and supervisory) to send email to the support team.
Chat: Allows users (leisure and supervisory) to chat with bot for immediate help.

Mode Module:
Cloud: Give Learners and Supervisors the option to use software either online or offline.
Sync: Allows users to sync when they choose, and to set sync option (mobile data or Wi-Fi).

Operating Environment: In certain embodiments, the software can operate in any of the following:
Windows 10
Mac OS
iOS
Android 25 and up

Design and Implementation Constraints:
In certain embodiments, the gaming component is implemented in Unreal Engine 4 with C++, and other external components are built with Java and Python, native on Oracle cloud. The design can be modular where every feature is wrapped into a separate and the modules depend on each other through well-written APIs. Several open-source APIs that are available to make plugin development easy are utilized.

Assumptions and Dependencies:
In certain embodiments, the technology is run in Java, and therefore will require Java to be installed on the user's system for offline running only. This applies to Windows users. On Mac OS X, Java can be bundled with the application.

Although the present technology has been described in relation to particular embodiments thereof, these embodiments and examples are merely exemplary and not intended to be limiting. Many other variations and modifications and other uses will become apparent to those skilled in the art. The present technology should, therefore, not be limited by the specific disclosure herein, and can be embodied in other forms not explicitly described here, without departing from the spirit thereof.

We claim:

1. A quantification method of a subject's learning and intellectual abilities, the method comprising of:
(a) Cognitive quotient measures the cognitive recollection of the user based on a subject's ability to navigate through the maze with respect to time. Outside a maze, it's the measure of a subject's ability to cognitively recollect complex scenarios or patterns with respect to time.
(b) Learning rate measures an individual's ability to understand and apply new concepts introduced with respect to time.

2. A method of assessing a subject's educational needs, the method comprising the steps of:
(a) Providing the subject with an Initial Assessment, the results of the Initial Assessment comprising: a Cognitive Quotient, a Learning Rate, a Preferred Learning Style, and an Educational Level;
(b) Creating a customized Educational Curriculum based on the results of the Initial Assessment, by forming a Learning Path determined by the Cognitive Quotient, Learning Rate, Preferred Learning Style and Educational Level.

3. The method of claims 1 and 2, wherein the Initial Assessment comprises: (i) an Educational Level Placement Test; and (ii) a Learning Style Test; wherein the Educational Level is calculated from the Educational Level Placement Test; the Preferred Learning Style is calculated from the Learning Style Test; and the Learning Rate and the Cognitive Quotient are calculated from both the Educational Level Placement Test and the Learning Style Test.

4. The method of claim 3, wherein the Educational Level Placement Test comprises a Verbal Test, a Quant Test, a Social Test, and a Disorders Test; wherein the subject must take the Verbal Test, Quant Test, and Social Test, while said Disorders Test operates concurrently and passively during each of said Verbal Test, Quant Test, and Social Test; wherein the Verbal Test, Quant Test, and Social Test together comprise the Maze Game; wherein the results of the Verbal Test, Quant Test, Social Test and Disorders Tests together determine the Learner's Educational Level.

5. The method of claim 4, wherein the Learning Style test comprises one or more Lessons connected to one or more Tests; wherein the Educational Level calculated is used to randomly select a Lesson and randomly apply a Learning Style from a library of learning styles to the Lesson, the subject watches the Lesson in which the selected Learning Style is applied, the subject takes a Test connected to the Lesson, wherein one Test comprises a Maze Game, and the result of the Test is used to determine the Learner's Preferred Learning Style.

6. The method of claim 2, wherein the subject watches Lessons in the Educational Curriculum through the Learning Path and progresses through the Educational Curriculum.

7. The method of claim 6, wherein the subject's Cognitive Quotient, Learning Rate, Educational Level, and Preferred Learning Style are updated based on the subject's progress through the Educational Curriculum.

8. A system for assessing a subject's educational needs, the system comprising: Two apparatuses each comprising: a graphical interface, a central processing unit configured to accept input from a from a user through an input element; wherein the two or more apparatuses are connected through a communicational link; and wherein the first apparatus is operated by a Supervisor, and the second apparatus is operated by a Learner; the system configured such that:
(a) the Supervisor registers the Learner through the first apparatus;
(b) the Supervisor subjects the Learner to an Initial Assessment, wherein the results of the Initial Assessment are a Cognitive Quotient, a Learning Rate, a Preferred Learning Style, and an Educational Level; and these results are displayed to the Supervisor through the first apparatus;
(c) the Supervisor provides the Learner with an Educational Curriculum based on the results of the Initial Assessment, by forming a Learning Path for the Learner determined by the Learner's Cognitive Quotient, Learning Rate, Preferred Learning Style and Educational Level;
(d) the Learner starts the Educational Curriculum and a Maze Game;
(e) the Supervisor contemporaneously monitors, through the first apparatus, one or more Learner's activities in the Educational Curriculum and Maze Game while operating the second apparatus; and
(f) the Learner's Learning Rate and Cognitive Quotient are recalculated based on the results of the Learner's progress through the Educational Curriculum and Maze Game.

9. The system of claim 8, wherein the input element comprises a touch screen, microphone, keyboard, video camera or a picture scanner capable of scanning and uploading pictures or photographs.

10. The system of claim 9, further comprising a third apparatus operated by a second Learner.

11. The method of claims 1 and 2, wherein the methods are implemented in systems for all forms of computer enabled learning platforms.

12. The system of claim 8, wherein the curriculum is tailored for varied forms of professional instruction.

13. The method of real-time storytelling character generation and animation to in response to voice narration from the user.
